(19) United States
(12) Patent Application Publication
(10) Pub. No.: US 2026/0291032 A1
(43) Pub. Date: Sep. 24, 2026

(54) ENERGY STORAGE CELL

(71) Applicant: Tesla, Inc., Austin, TX (US)

(72) Inventors: Andrew Pires, San Francisco, CA (US); Jayesh Gorasia, San Francisco, CA (US); Cole Prodan, Mountain View, CA (US); Vincent Jen-Bang Peng, Austin, TX (US)

(21) Appl. No.: 18/874,296

(22) PCT Filed: Jun. 14, 2023
(86) PCT No.: PCT/US2023/025289

§ 371 Date: Dec. 12, 2024

Related U.S. Application Data
(60) Provisional application No. 63/366,454, filed on Jun. 15, 2022.

(51) Int. Cl. H01M 50/566; H01G 11/14; H01G 11/78; H01M 50/107; H01M 50/184; H01M 50/186; H01M 50/213; H01M 50/342; H01M 50/55; H01M 50/559

(52) U.S. Cl. CPC H01M 50/566; H01M 50/107; H01M 50/184; H01M 50/186; H01M 50/213; H01M 50/3425; H01M 50/55; H01M 50/559; H01G 11/14; H01G 11/78

(57) ABSTRACT

A system for incorporating one or more individual energy cells is provided. Individual energy cells include a top surface having a center terminal and an outer terminal. The top surface may include a pressure venting element configured for venting in an opposite direction of a bottom surface. The first terminal and the second terminal may be substantially planar electrical contacts.

### INCORPORATION BY REFERENCE TO ANY PRIORITY APPLICATIONS

The present application claims priority to U.S. Provisional Patent Application No. 63/366,454, filed Jun. 15, 2022, the disclosure of which is incorporated herein by reference in its entirety and for all purposes.

### BACKGROUND

### Field

The present disclosure relates generally to energy storage devices, and specifically to improved energy storage device housings.

### Description of the Related Art

Generally described, a number of devices or components may be powered, at least in part, by an electric power source or energy storage device. In the context of vehicles, electric vehicles may be powered, in whole or in part, by a power source. An example of a power source for an electric vehicle may be a “battery,” which can represent an individual battery cell or multiple cells utilized in modules and/or packs. In some approaches, a cluster of cells can be considered as individual modules and a cluster of modules can be considered a pack. The power sources for electric vehicles can be installed and maintained in a pack configuration. Similar approaches/terminology can apply to grid storage application for collecting, storing and distributing energy,

Electric vehicles typically require a large multiple of power, such as a thousand times stronger than that of a typical consumer product (e.g., a mobile device). To achieve these power requirements, the energy storage pack (e.g., battery pack) of electric vehicles typically include a large, dense arrangement of individual cells, individually placed or configured into a plurality of modules. The composition and performance of the energy storage pack will depend on the characteristics of the individual cells, the total number of individual cells that are incorporated into the energy storage pack, and configurations/orientations of the cells and ancillary components into modules or the energy storage pack. The energy storage pack may represent one of the most expensive and massive assemblies in the context of most electric vehicle transportation and grid storage applications.

Due to the large amount of power stored in the energy storage devices, an energy storage device may have the ability cause damage to the surrounding (e.g., vehicle parts and other energy storage devices) and/or harm individuals if the cell were defective or damaged. As such, energy storage device safety features may aid in reducing damage and harm potentially caused by such cells.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, an energy cell is disclosed. The energy cell comprises: a circular top surface having a center terminal, an outer terminal, and a terminal insulator gasket, wherein the circular top surface includes a pressure venting element, wherein the center terminal and the outer terminal are configured as electrical contacts, wherein the center terminal is encircled by the outer terminal, wherein the pressure venting element encompasses the center terminal and the outer terminal, wherein the center terminal and the outer terminal are separated by the terminal insulator gasket, wherein the terminal insulator gasket is an electrical insulator; and wherein the pressure venting element is configured to at least be partially removed in response to a venting force in an opposite direction of the bottom surface; a side surface mechanically connected to the top surface; a circular bottom surface mechanically connected to the side surface having an annular interface, wherein, the annular interface configured to form a base for the cell; an energy storage material within the top surface, the side surface, and the bottom surface.

In some embodiments, the top surface and the side surface are contiguous. In some embodiments, an area of the center terminal and an area of the outer terminal are configured to be dependent. In some embodiments, an area of the center terminal and an area of the outer terminal are determined based on a threshold of statistical likelihood that a cell array-level interconnect welding or other assembly process will be successful.

In another aspect, an energy cell is disclosed. The energy cell comprises: a top surface having a center terminal and an outer terminal, wherein the first terminal and the second terminal are configured as substantially planar electrical contacts, wherein the top surface includes a pressure venting element configured for venting in an opposite direction of a bottom surface; a side surface mechanically connected to the top surface; wherein the bottom surface mechanically connected to the side surface; and an energy storage material within the top surface, the side surface, and the bottom surface.

In some embodiments, the top surface is substantially circular. In some embodiments, the center terminal and the outer terminal substantially cover the top surface. In some embodiments, the pressure venting element is defined to encompass the first and second terminal. In some embodiments, a first portion of the top surface is removed in response to the venting in the opposite direction of the bottom surface. In some embodiments, at least a second portion of the top surface remains intact in response to the venting in the opposite direction of the bottom surface. In some embodiments, the center terminal and the outer terminal are separated by a terminal insulator gasket, wherein the terminal insulator gasket is an electrical insulator. In some embodiments, the center terminal is a cathode and the outer terminal is an anode. In some embodiments, an area of the center terminal and an area of the outer terminal are configured to be dependent.

In some embodiments, an area of the center terminal and an area of the outer terminal are determined based on a threshold of statistical likelihood that a cell array-level interconnect welding or other assembly process will be successful. In some embodiments, the venting element defines an area encompassing at least one of the outer terminal or the center terminal for attaching at least one positive and one negative lead, the at least one positive and one negative lead corresponding to the array-level interconnect welding. In some embodiments, the at least one negative and positive leads are severed in response to the venting in the opposite direction of the top surface. In some embodiments, the top surface and the side surface are contiguous. In some embodiments, the top surface is sufficiently ferrous to allow movement via magnetic adhesion by manufacturing equipment. In some embodiments, the bottom surface has an annular interface configured to form a base for the cell.

In another aspect, a battery system is disclosed. The battery system comprises: a plurality of cells, wherein each of the cells includes: a top surface having a center terminal and an outer terminal, wherein the first terminal and the second terminal are configured as electrical contacts wherein the top surface includes a venting element configured to disengage a portion of the top surface in response to a pressure spike, the portion of the top surface defined by an area defined by the venting element; a side surface mechanically connected to the top surface; a bottom surface mechanically connected to the side surface; and an energy storage material within the top surface, the side surface, and the bottom surface, wherein the cells are interconnected by laser welds and aligned in a substantially planar configuration.

In another aspect, an energy storage device is disclosed. The energy storage device comprises: a first terminal; a second terminal; a pressure venting element; a housing comprising a housing surface, wherein the housing surface comprises the first terminal, the second terminal and the pressure venting element; and an energy storage material disposed within the housing.

In some embodiments, the pressure venting element comprises a material selected from a group consisting of a machined material, a degraded material, a shaped material, and combinations thereof. In some embodiments, the pressure venting element comprises a material selected from a group consisting of a stamped material, a pierced material, a welded material, an etched material, a chemically treated material, a carved material, and combinations thereof. In some embodiments, the pressure venting element comprises a venting surface thickness, the housing surface comprises a housing surface thickness, and the venting surface thickness is thinner than the housing surface thickness. In some embodiments, the housing surface comprises an external surface and an internal surface, wherein a position of the pressure venting element is selected from a group consisting of the external surface, the internal surface, and combinations thereof. In some embodiments, the energy storage device further comprises a terminal insulator gasket positioned between the first terminal and the second terminal.

In some embodiments, the housing surface comprises a top surface, a side surface and a bottom surface. In some embodiments, the first terminal, the second terminal and the pressure venting element are positioned on the top surface. In some embodiments, the first terminal and the second terminal are positioned on the top surface, and the pressure venting element is positioned on the bottom surface. In some embodiments, the first terminal and the second terminal are positioned on the top surface, and the pressure venting element is positioned on the side surface. In some embodiments, the top surface is substantially circular. In some embodiments, the bottom surface comprises a substantially annulus shaped surface.

In some embodiments, the first terminal is encircled by the second terminal, and wherein the pressure venting element encircles the first terminal and the second terminal. In some embodiments, the first terminal and the second terminal are each substantially planar. In some embodiments, the housing is substantially cylindrical. In some embodiments, the first terminal and the second terminal together cover at least about 50% of a surface area of a top surface. In some embodiments, the first terminal and the second terminal together cover at least about 75% of a surface area of a top surface. In some embodiments, the first terminal and the second terminal are substantially flat. In some embodiments, the first terminal comprises a first terminal shape selected from a group consisting of a circular shape and an annular shape. In some embodiments, the second terminal comprises an annular second terminal shape. In some embodiments, a width of the first terminal is about 5-15 mm. In some embodiments, a width of the second terminal is about 5-15 mm. In some embodiments, an aspect ratio of a first terminal size: a second terminal size is about 3:1 to about 1:3.

In some embodiments, the first terminal is a cathode terminal and the second terminal is an anode terminal. In some embodiments, the energy storage device further comprises a positive lead in contact with the anode terminal and a negative lead in contact with the cathode terminal. In some embodiments, the positive and negative leads are respectively welded to the anode and cathode terminals. In some embodiments, the positive and negative leads are respectively laser welded to the anode and cathode terminals. In some embodiments, a portion of the housing surface is substantially ferrous. In some embodiments, the pressure venting element comprises a venting pressure of at least about 20 Bar. In some embodiments, the energy storage device further comprises a housing cap. In some embodiments, the energy storage device further comprises a housing port.

In another aspect, an energy storage device is disclosed. The energy storage device comprises: a first terminal; a second terminal, wherein the second terminal encircles the first terminal; an insulating gasket positioned between the first terminal and the second terminal; a housing comprising a housing surface, and an energy storage material disposed within the housing; wherein the housing surface comprises a top surface, a side surface and a bottom surface; wherein the top surface comprises the first terminal and the second terminal; and wherein the first terminal and the second terminal are each substantially planar.

In some embodiments, the first terminal protrudes from the top surface. In some embodiments, the second terminal is substantially level with the top surface. In some embodiments, the first terminal and the second terminal together cover at least about 50% of a surface area of the top surface. In some embodiments, a width of the first terminal is about 5-15 mm. In some embodiments, a width of the second terminal is about 5-15 mm. In some embodiments, an aspect ratio of a first terminal size: a second terminal size is about 3:1 to about 1:3. In some embodiments, the energy storage device is a battery.

In another aspect, an energy storage device array is disclosed. The array comprises a plurality of energy storage devices, wherein the plurality of energy storage devices comprises the energy storage device.

In another aspect, an electric vehicle is disclosed. The electric vehicle comprises the energy storage device.

In another aspect, a process of manufacturing an energy storage device is disclosed. The process comprises: forming a pressure venting element on a housing surface of a housing, wherein the housing surface comprises a first terminal and a second terminal; disposing an energy storage material within the housing; and attaching the energy storage material to the first terminal and the second terminal.

In another aspect, a process of manufacturing an energy storage device array is disclosed. The process comprises: disposing the energy storage device into an array housing; contacting a first lead to the first terminal and a second lead to the second terminal; and attaching the first lead to the first terminal and the second lead to the second terminal. In some embodiments, a position of a battery is not adjusted after the energy storage device is disposed into the array housing. In some embodiments, the attaching the first lead to the first terminal and the second lead to the second terminal comprises laser welding.

### BRIEF DESCRIPTION OF THE DRAWINGS

These and other features, aspects, and advantages of the present disclosure are described with reference to the drawings of certain configurations, which are intended to schematically illustrate certain configurations and not to limit the disclosure.

FIG. 1A illustrates an example energy storage cell in a sleeve.

FIG. 1B illustrates a perspective view of an example energy storage cell.

FIG. 1C illustrates a perspective view of an example energy storage cell.

FIG. 2A illustrates a top view of an example energy storage cell.

FIG. 2B illustrates an alternate top view of an example energy storage cell.

FIG. 3 illustrates a bottom view of an example energy cell.

FIG. 4 illustrates a side view structural diagram of the top surface and bottom surface of an example energy cell.

FIG. 5 illustrates an exploded view of an example energy storage system.

### DETAILED DESCRIPTION

Although certain embodiments and examples are described herein, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described herein.

Generally described, one or more aspects of the present disclosure relate to energy storage cells. More particularly, the present disclosure relates to an energy storage cell that is designed for integration into large-scale vehicle and grid storage products. Illustratively, to support such integration, in some embodiments individual energy storage cells can correspond to cylindrical shaped storage cells of various volumes and aspect ratios. The cylindrical storage cells have specific characteristics or configurations that further support integration. More specifically, in one aspect, in some embodiments the cylindrical storage cells include a top surface that is configured specifically to present concentric and substantially co-planar positive and negative terminals such that the surface area for welding interconnects offers statistically balanced outcomes between positive and negative terminals. In another aspect, in some embodiments the center terminal interface (be it positive or negative) may be elevated relative to the surrounding geometry, including the other terminal, the terminal insulator gasket which serves as an electrical insulator between the two terminals, or another element of the cell canister. In some embodiments, the top surface can include one or more components for calibrated venting in thermal runaway. In some embodiments, such components can illustratively correspond to a terminal venting disk as described herein.

In another aspect, in some embodiments the cylindrical storage cells include a side surface that is sleeved to electrically isolate individual cells from each other and ancillary components in a cell array. Additionally, in some embodiments the side surface illustratively functions to interface with cooling systems added as part of the cell array, serving as the primary conduit for extracting heat generated within individual cells.

In still another aspect, in some embodiments the cylindrical storage cell design includes a bottom surface that selectively groups cell features or functionalities that in prior art may have required incorporation into either the top surface or side surface. Such additional features can include features similar, complementary, or alternatively to the top surface which include geometry for sealing of the open end of a drawn or extruded cell can. Additionally, in some embodiments the bottom surface can be reinforced in a manner that a force, generally referred to as a pressure force, pressure spike, ejection force, etc., experienced by the cell, e.g., forces resulting from thermal runaway, will prefer a top surface ejection over ejection of the bottom surface.

In an illustrative embodiment, the specific combination of above-described aspects of the top surface, side surface, and bottom surface of the cylindrical storage cell facilitates an increased optimization of the functions implemented by each respective surface. For example, the functionality or components presented on the top surface to the positive and negative terminal, the illustrative cylindrical storage cell can increase the surface area of the top surface corresponding to the positive and negative terminals and thereby facilitate welding of electrical interconnects via manufacturing processes, such as laser welding. This can improve economic and performance characteristics. In another example, the utilization of sleeve materials having additional temperature conducting properties enables the establishment of cost and performance-optimized cooling channels in a cell array embodiment. One skilled in the relevant art will appreciate that additional examples and benefits are also facilitated by such configurations or combinations. Additionally, one skilled in the relevant art will appreciate that other storage cell implementations within the scope of the present application may incorporate different combinations of aspects of the surfaces presented herein.

Various energy storage cell designs attempt to optimize cost, package volume, mass, performance, durability, and manufacturing efficiency at the individual cell level. However, such localized optimizations typically do not translate into system-level metric optimizations for energy storage systems into which the storage cells are integrated, for example with cell arrays utilized in electric vehicles or grid energy storage systems. Cell form factor selection offers efficient and effective leverage on the resulting performance, cost, package volume, durability, and manufacturing efficiency of a battery pack. Three distinct form factors are most typically used in large-scale product applications: pouch cells, prismatic cells, and cylindrical cells. In some embodiments, the cylindrical format offers decisive benefits in cost/manufacturing efficiency, via single-piece continuous motion assembly processes, and packaging/durability, via internally resolved electrode stack material expansion forces. Cylindrical formats may also generally yield improvements in performance, via shorter thermal path lengths, and volumetric energy density, via wrapped geometry of the electrode stack. One skilled in the relevant art will appreciate that in order to manifest aforementioned cylindrical format advantages at the level of an integrated battery pack, the materials and mechanical features of the individual cell, including the cell exterior, may impact the ability to integrate a plurality of cells to achieve functionality of the battery pack. Accordingly, specific feature and functionality configurations across various surfaces of individual cylindrical storage cells, as described herein, can provide additional product system-level optimizations of costs, package volume, mass, performance, durability, and manufacturing efficiencies for integrated cell arrays.

Although the present disclosure focuses on its use in energy storage systems, in some embodiments the cylindrical energy storage cell design may be utilized to improve any energy storage device of cylindrical form factor (batteries, capacitors, etc.) where automated manufacture of a cost, volume, performance and mass-sensitive large array product is a priority outcome. One skilled in the relevant art will appreciate additional advantages or technical efficiencies may be associated with one or more aspects of the present application or combinations of aspects without limitation.

### Energy Storage Cells

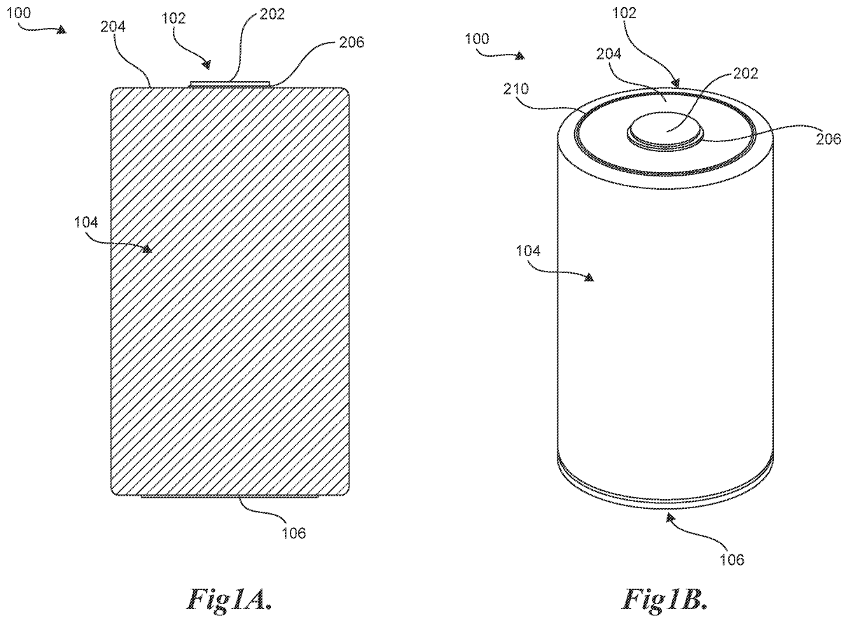

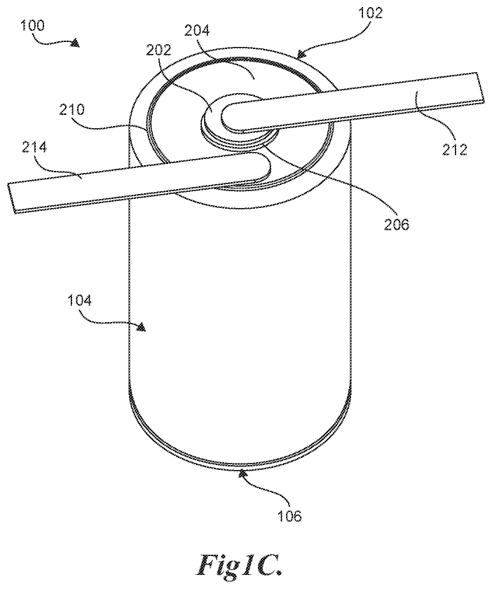

FIG. 1A shows a sectioned sideview of an illustrative cylindrical energy storage cell 100. The storage cell 100 may have a top surface 102, a side surface 104, and a bottom surface 106. The side surface 104 may comprise the cell wall of the storage cell 100. Cell dimensions (such as height and diameter, and the like) may be optimized to form repeating pattern of same-voltage clusters across a variety of energy storage systems, such as, but not limited to, vehicle battery platforms and energy grid networks at various bus voltages. Materials used for construction of the storage cell 100 may be chemically and thermally compatible with both internally and externally contacting substances in a given energy storage application. Although illustrated as a cylindrical-shaped embodiment in FIGS. 1A and 1B, in other embodiments, the energy storage cell 100 may have non-cylindrical form, such as a prismatic or pouch form factor.

FIG. 1B shows a perspective view of an illustrative cylindrical energy storage cell 100. The side surface 104 can be part of a continuous structure forming the structure of the cell. The top surface 102 and the side surface 104 can be contiguous (for example, materially contiguous, mechanically contiguous, or any other form of contiguity or continuousness). Similarly, the bottom surface 106 and the side surface 104 can be contiguous. For example, the outer structure of a cell is often referred to as the “can,” and in which the side surface can be referred to as the “can wall.” Illustratively, the side surface 104 of the cell may be contiguous with the top surface 102 or the bottom surface 106 to reduce the number or severity of mechanical and electrical weak points on the cell. For example, in embodiments in which the side surface 104 is contiguous with the top surface 102, the cell presents a locally homogeneous structure in terms of stiffness and strength. Such a cell structure may be better suited for handling mechanical load, pressure, or stress that is applied, or otherwise experienced, at the top surface 102. This can also be advantageous for assembly of the cell or for assembly of a product in which the cell is used by, eliminating mechanical weaknesses and associated assembly errors. In some embodiments, the top surface 102 or bottom surface 106 may be a housing cap, that is added to the energy storage cell 100 to form a housing enclosure for the energy storage material disposed within.

Additionally, the top surface 102, as described below, can be used to handle part of the mechanical load, pressure, or stress applied to the top surface 102 once a cell is deployed for use. Illustratively, the top surface 102 can be configured for increased tensile strength and stiffness for product structure integration and compressive strength and stiffness to react fixturing forces during electrical interconnect processes. More specifically, the top surface 102 can be bonded directly to a sheet such that an array of cells 100 creates a sandwich panel structure that offers sufficient strength and stiffness to support its own mass, or additionally, a product frame (such as a vehicle body). It should be noted that, although illustrated to be circular in FIG. 1B, the top surface 102 can be of any other suitable shapes (e.g., polygon).

As will be described herein with regard to FIG. 1C, in some embodiments, the top surface 102 can include a venting element 210 that will cause at least some portion of the top surface 102 to release from the cell 100 in a manner that severs one or both cell array electrical interconnects 212, 214, and allows for the release of venting gasses or other material via an opening created with the ruptured portion of the top surface. In some embodiments, the venting element 210 is illustratively defined as a circular shape seal such that defines the outer perimeter of the top surface that at least partially or fully disengages from any remaining portions of the top surface 102. The venting element 210 may be comprised of a material that attributes sufficient weakness to cause disengagement of the portion of the top surface 102 from the cell 100. In other embodiments, the venting element 210 can be formed utilizing manufacturing techniques, such as coining, to create material or geometric weaknesses in the portion of the top surface 102 to encourage disengagement as described herein. In other embodiments, the venting element 210 can be configured into other favorable shapes (e.g., ovals, diamond, square, rectangular, spiral etc.) or combinations thereof, to generate non-uniform, asymmetric, or multi-element designs. Although not illustrated in FIG. 1B, in some embodiments the venting element 210 can be positioned on other surfaces of the cell 100. For example, in some embodiments the venting element 210 can be positioned on the side surface 104, the bottom surface 106, and/or around the boundary between two surfaces (e.g., top surface 102 and side surface 104). Although FIG. 1B depicts the venting element 210 positioned on an external surface of a surface of the cell 100, in some embodiments, the venting element 210 may be additionally or alternatively positioned on an internal position surface of the cell 100.

In some embodiments, a sleeve can be applied to an outer surface of the storage cell 100. The sleeve can substantially encompass at least the cylindrical side surface 104 of the cell 100. Illustratively, the cylindrical side surface 104 is made up of an electrically conductive material. In some embodiments, the sleeve does not substantially encompass the cylindrical side surface 104 of the cell, but rather can be comprised of one or more bands that partly expose the side surface 104 of the cell 100. These bands of the sleeve can be spaced equidistance from each other along the height of the cylindrical side surface 104 of the cell or can be placed substantially close to the top surface 102 of the cell or the bottom surface 106 of the cell. When the sleeve comprises one or more bands, the sleeve enables electrically isolated physical contact between cells and other components (including other cells), while maintaining opportunity for direct mechanical bonding to the side surface 104 of the cell 100.

In some embodiments, the sleeve can be an electrically insulating material. The sleeve may create an electrical barrier that electrically isolates each energy storage cell from other energy storage system components, such as a product frame, other storage cells, and cooling systems. The sleeve may facilitate the construction or configuration a plurality of storage cells 100 corresponding to a series voltage string with maximum volumetric packing density of battery cells 100. In this configuration, the sleeve mitigates undesired electrical connectivity between individual cells, allowing the cell array to eliminate spacing gaps between storage cells. Use of a sleeve may thus allow several benefits in energy storage systems, including, but not limited to, improving volumetric energy density, reducing internal void volume (which directly reduces cost for structurally-filled module and battery pack configurations), encouraging balanced distribution of thermal energy from provoked or unprovoked thermal runaway (which reduces likelihood of propagation to module or pack-level safety event), enforcing cell spacing as a bumper, buffer or mechanical shim between cells, and allowing neighboring components to be electrically or thermally conductive for application-specific performance improvement.

Alternatively, the sleeve can be used as a bumper, buffer, or mechanical shim to physically enforce cell separation without itself serving as the primary electrically insulative medium. Using the sleeve as a bumper or buffer to enforce cell spacing can reduce movement and pitch of the cell. In some embodiments, the sleeve can be a label for the cell and include information about the cell such as regulatory information or important usage details.

In some embodiments, the sleeve is a single wrapping of a material. In some embodiments, the sleeve is a double wrapping of one or two materials. The double wrapping can be useful if key performance properties of one or both wrappings degrade over time. A double wrapping can further be useful for improved serviceability, by creating a sliding interface layer which simplifies cell removal from and replacement within a cell array.

In other embodiments, the storage cell 100 may be manufactured without the sleeve such that the electrically conductive side surface is exposed. In such embodiment, during use in an energy storage system, then, the storage cells 100 may be arranged such that a distance remains between storage cells 100 and other components of the energy storage system. If distance between storage cells 100 is undesired in such an embodiment, the cells in adjacent same-voltage clusters may be configured with inverted terminal polarity such that direct contact between side surfaces 104 results in zero electrical potential, thereby rendering the contact inconsequential for constructing a series voltage stack.

With reference to FIG. 1B, the side surface 104 may be designed to facilitate air, liquid, or passive cooling along through a section of the side surface 104 where there exist no other competing functions. In some embodiments, the side surface 104 may interface with an active cooling channel or cooling component (for example, a heat sink) provided as part of the manufacturing of the cell array. Accordingly, the side surface 104 and sleeve (individually or in combinate) may present to have a superior thermally conductive pathway as compared to one or both other surfaces of the storage cell 100. In some embodiments, the storage cell 100 may be cooled via the top surface 102 or bottom surface 106. Any subgroup of these interfaces could be cooled simultaneously, or all of them together (for example, immersion, phase-change, etc.), or not cooled at all (passive/rely on thermal capacity of the cell). In some embodiments, the side surface 104 can be swept cylindrically around the cell. In some embodiments, the side surface 104 can be curved near the top surface 102 or the bottom surface 106. Cooling the side surface 104 can be used alternatively to cooling the top surface 102 and the bottom surface 106. This in turn can allow for the design of the top surface 102 and the bottom surface 106 to be primarily designed for pressure venting, electrical terminal cell functions, and structural connections. Cooling the side surface 104 can also be advantageous for maximizing cell canister height which can be packaged in a fixed vehicle product height envelope, in effect, minimizing cell active material cost/mass overheads. Such a cooling arrangement also enables removal of thermal management interfaces from typical abuse zones in the series load path for a structurally integrated energy storage system. This configuration can offer additional thermal benefits, for example by minimizing rate of heat leak to ambient environment such that the cells provide thermal storage for warming a vehicle cabin. In embodiments where the side surface 104 is cooled, the sleeve may not be of high thermal resistance.

The side surface 104 may be further used for precise positioning of the storage cell 100 in an energy storage system, by aligning the side surface 104 with complementary rigid components in the energy storage system. In some embodiments, the complementary component may be a thermal component in the energy storage system.

The side surface 104 can have a thickness of 0.1-2 mm. In some embodiments, the side surface 104 can have a thickness of, of about, of at most, or of at most about, 0.05 mm, 0.1 mm, 0.2 mm, 0,3 mm, 0.4 mm, 0.5 mm, 0.6 mm, 0.7 mm, 0.8 mm, 0.9 mm, or 1.0 mm. The side surface 104 can have a thickness of about 1.1 mm, 1.2 mm, 1.3 mm, 1.4 mm, 1.5 mm, 1.6 mm, 1.7 mm, 1.8 mm, 1.9 mm or 2 mm, or any range of values therebetween. The side surface 104 can have a thickness of 0.05 mm. A thinner side surface 104 can be used to enable higher volumetric energy density. The wall (referring to the side surface 104) may be thicker if the cell size is longer or has a longer electrode. Important factors in considering side surface thickness include mechanical strength due to fatigue over time, resistance to side rupture potentially from large hoop stress due to internal pressure, and balancing thermals to act as a parallel resistor during cooling/heating the cell.

The top surface 102 or bottom surface 106 can be comparatively thicker as compared to the side surface 104. One or more of the top surface 102 or bottom surface 106 can have a thickness of 0.1-2 mm. In some embodiments, the top surface 102 or bottom surface 106 can have a thickness of, of about, of at least, or of at least about, 0.1 mm, 0.2 mm, 0.3 mm, 0.4 mm, 0.5 mm, 0.6 mm, 0.7 mm, 0.8 mm, 0.9 mm, or 1.0 mm. The top surface 102 or bottom surface 106 can have a thickness of about 1.1 mm, 1.2 mm, 1.3 mm, 1.4 mm, 1.5 mm, 1.6 mm, 1.7 mm, 1.8 mm, 1.9 mm, or 2 mm, or any range of values therebetween. In some embodiments, the top surface 102 can further have varying thicknesses, especially to define the venting element 210, which may have a relatively thinner surface (e.g., as a result of coining) to encourage rupture at the venting element 210.

A thicker top surface 102 or bottom surface 106 can provide additional substrate for electrical connections. A thicker top surface 102 or bottom surface 106 can be useful for stronger welds to the side surface 104 with optionally greater interconnect process windows. A thicker top surface 102 or bottom surface 106 can be useful to enable for more heat transfer away from electrical joints during normal operation of the cell, thus enabling high thermal performance capability. A thicker top surface 102 or bottom surface 106 can be useful for manufacturing for containing more of the magnetic flux from material handling or assembly equipment during cell and final product assembly. This in turn can enable the manufacture of taller cells and higher factory operation speeds. As described above, in some embodiments, the configuration of the bottom surface 106 can be selected to encourage forces experienced within the cell 100 (e.g., thermal runaway) to be released through the top surface 102, such as the illustrated portion of the top surface 102 illustratively defined by an outer edge/perimeter corresponding to the venting element 210. Additionally, any portion of the top surface 102 outside of the outer edge/perimeter defined by the venting element 210 would not be released by any venting forces or pressure spikes and may be utilized to mechanically retain internal contents or assist in controlled or directed expulsion of vented materials through the resulting orifice.

FIG. 1C illustrates the addition of two interconnects 212 and 214 that are connected respective to the positive connection and negative connection provide by the top surface 120. In some embodiments, the coupling of the interconnects 212, 214 to the top surface is specifically design such that the rupturing of the venting element 210 will also cause at least one of two electrical connections to top surface 102 to fully disconnect, and provide runaway venting functionality. In one embodiment, the welding of the interconnects 212, 214 may be implemented in accordance with a maximum allowed strength to facilitate severing of the interconnects 212, 214. In other embodiments, the interconnects 212, 214 may be scored or preconfigured in a manner that the rupturing of the venting element 210 and the resulting expulsion of the top surface 102 will cause the interconnects to break. For example, the interconnects 212, 214 may be made of a material, such as aluminum, that may have a relative lower melting temperature that would allow for the destruction of the interconnects 212, 214 in a thermal runaway venting scenario. In still other embodiments, a combination of such embodiments or alternatives to cause a release of the interconnects 212, 214 may be utilized. Illustratively, the interconnects 212, 214 are configured such that both interconnects may be separated relatively simultaneously to preclude the possibility of post-runaway short circuit scenarios.

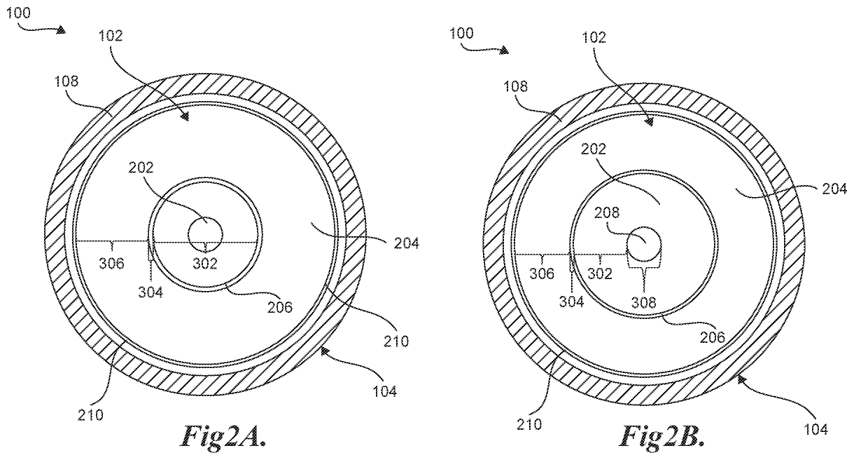

FIG. 2A illustrates the top surface 102 of the storage cell 100. The top surface 102 may comprise electrically conductive material configured as concentric positive and negative terminals, depicted as a center terminal 202 and an outer terminal 204 in FIG. 2A. The center terminal 202 and the outer terminal 204 can be marked with text, symbols, colors, geometric features and the like to allow for identification of each terminal or the boundaries of each terminal. In some embodiments, the center terminal can be surrounded by a terminal insulator gasket 206. The terminal insulator gasket 206 can act as an electrical insulator (or dielectric insulator) between the center terminal 202 and the outer terminal 204. The center terminal 202 and the outer terminal 204 can be joined with other components to deliver electrical power to other systems, subsystems, or components. The center terminal 202 and/or the outer terminal 204 can be configured externally to improve suitability as electrical contacts. Such external configurations can improve material compatibility and area and thickness available for making electrical joints with the center terminal 202 and/or the outer terminal 204.

In some embodiments, the center terminal 202 is the positive terminal and the outer terminal 204 is the negative terminal. In other embodiments, the center terminal 202 is the negative terminal and the outer terminal 204 is the positive terminal. In some embodiments, the center terminal 202 may be one solid conductive component, protruding from the top surface 102 (for example, protruding from the terminal insulator gasket 206 and/or outer terminal 204), which minimizes interference with interconnecting components at the cell array level. The center terminal 202 may also be used as a gap-setting feature for adhesives, encapsulants, or heat sinking elements. The sleeve 108 may overlap onto the outer perimeter of the top surface 102 to prevent accidental bridging of positive and negative terminals between adjacent storage cells in the energy storage system, or to enforce a minimum across-surface “creepage” from conductive components at differing electrical potential, such as the cooling system or product frame.

In some embodiments, the top surface 102 can include a cell pressure venting element 210. The cell pressure venting element 210 can be designed to allow a storage cell 100 that is undergoing thermal runaway to mechanically destroy or disconnect the storage cell's 100 own electrical connections to other cells in the cell array or to the energy storage system. Similarly, the cell pressure venting element 210 can separate one or both of the center terminal 202 and the outer terminal 204 from any combination of the following: the rest of the top surface 102, from the walls of the cell 100, or from electrically connecting to interconnects 212, 214. The pressure venting element 210 on top surface 102 can improve cell failure scenario repeatability, in particular, by further directing high-temperature gas, debris, and flame away from neighboring cells, sensitive components, and product users. By steering these hazards more deterministically, the probability of propagating thermal runaway and injury can be reduced.

The cell pressure venting element 210 can be large enough to encompass both the center terminal 202 and the outer terminal 204. The cell pressure venting element 210 can be close to the edge of the top surface 102. One skilled in the relevant art will appreciate that the area and shape of the cell pressure venting element 210 may be tuned to balance manufacturing assembly outcomes with runaway venting performance characteristics. For example, in some embodiments, the venting element 210 may not directly correspond to the outer edge of the top surface 102. Rather, the venting element 210 may be inset from the edge of the top surface such that some portion of the top surface 102 remains as part of the cell with the detachment or partial detachment related to a venting force or pressure spike. Additionally, the location and shape of the venting element 210 may further incorporate or take into account the available surface area presented by the outer terminal 204, which may be contained within or outside of the area defined by the venting element 210 to facilitate the welding of leads to the outer terminal 204. When contained within the area defined by the venting element 210, the disengagement of the top surface 102 (or portion thereof) will increase the likelihood that both electrical leads will be fully removed as explained above.

The center terminal 202 and outer terminal 204 of the top surface 102 may be tailored as maximally flat and obstacle-free viable weld areas, comprising substrate thicknesses and materials suitable for granting a broad interconnect energy process window-translating to interconnect assembly gapping robustness-with minimal risk of compromising hermeticity of the storage cell 100. Sufficient positive and negative terminal area may be provided for simultaneous foil down-holding, welding area, and four-probe Kelvin interconnect verification testing on opposing sides of each terminal weld. Because all positive and negative cell terminals for the storage cells 100 are placed substantially coplanar and in a common orientation, electrical interconnects required for power delivery and voltage sensing may also run along a single plane (for example, integrated as a foil sheet). Laser-welded interconnects along the common plane of the top surfaces 102 may create electrically conductive connections which are used to supply voltage and current with low heat loss, as well as connect voltage-sensing and controlling electronics with reduced manufacturing and operation expenditures. As described above, an associated strength of the welding of the interconnects can be based on a maximum allowed welding strength to allow for the severing of the connection.

In some embodiments, the top surface 102 can be made of a ferrous or magnetic material. In some embodiments, the center terminal 202 or the outer terminal 204 are made of a ferrous or magnetic material. In some embodiments, parts of the top surface 102 that are not the center terminal 202 or the outer terminal 204 include ferrous or magnetic material. Enough ferrous or magnetic material can be on the top surface 102 such that an assembly tool can be used to pick up the cell and entire battery assembly by magnetic attraction to the top surface 102.

In some embodiments, the side surface 104 can be made of the same ferrous or magnetic material as the top surface 102. Alternatively, the side surface 104 can be made of a different material. The side surface 104 can be made of a non-magnetic or non-ferrous material. The side surface 104 can be made of a lighter material (for example, aluminum).

In an illustrative embodiment, the dimensions of the circular areas presented by the center terminal 202 and the outer terminal 204 may be determined based on a threshold of statistical likelihood that a cell array-level interconnect process (for example, laser welding) will be successful. For example, in one embodiment, the threshold likelihood success may be set to 99.9999% (4 sigma) or a maximum failure rate of 0.0001 or lower. Still further, the dimensions of the circular areas presented by the center terminal 202 and the outer terminal 204 may be configured to be dependent. In one embodiment, a diameter of the center terminal 202 may be proportionally set to be one half (½) of a diameter of the outer terminal 204. In another embodiment, the flat conductive diameter of the center terminal 202 may be set roughly equal to the flat conductive radial width of the outer terminal 204. In some embodiments, the flatness or roughness (e.g., RMS) of a terminal (e.g., the center terminal 202 or the outer terminal 204) may be, be about, be at most, or be at most about, 2 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm or 500 μm, or any range of values therebetween. In these embodiments, the flatness of the terminal(s) may facilitate attachment (e.g., laser welding) to external interfaces (e.g., positive or negative leads) in production. One skilled in the relevant art will appreciate that other failure rates, thresholds, dependencies or proportionality may be implemented for different storage cells, manufacturing environments, thermal system configurations, or desired cell arrays. Additionally, in the event that additional functionality is implemented on the top surface 102, such as port 208 for receiving internal materials or for making physical connections, the dimension of the center terminal 202 or outer terminal 204 may be adjusted accordingly, as illustrated in FIG. 2B, in order to statistically rebalance interconnect welding or other assembly process outcomes. In embodiments where a relatively small fraction of outer terminal 204 surface is required for electrical interconnect, the remaining area can be utilized as an interface for cell terminal temperature instrumentation.

In some embodiments, the terminal insulator gasket 206 has a small radial width (for example, 0.1 mm). The terminal insulator gasket 206 can be thin enough to satisfy electrical creepage requirements at 4.2V potential. Alternatively, the terminal insulator gasket can be configured to satisfy electrical creepage requirements at 3.0V, 3.2V, 3.4V, 3.6V, 3.8V, 4.0V, 4.4V, 4.6V, 4.8V, or 5.0V. A thin terminal insulator can be useful to maximize electrical interface area on top surface 102.

As illustrated in FIG. 2A, the center terminal 202 has a center width 302, the outer terminal 204 has an outer radial width 306, and the gasket 206 has a gasket radial width 304. As illustrated in FIG. 2A, the center width 302 is associated with a diameter of the circle formed by the center terminal 202 ending at the gasket 206, while the outer radial width 306 and the gasket radial width 304 are the exposed annulus width portions of the outer terminal 204 and gasket 206, respectively, as viewed from the top of the cell ending at the pressure venting element 210 or outer terminal 204, respectively. In other embodiments, a radial width or center width may be associated with a side or a diagonal length of a polygon (e.g., square) or polygon annulus. In some embodiments, the length of the center width 302 may be, be about, be at least, or be at least about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 50 mm or 100 mm, or any range of values therebetween. In some embodiments, the length of the gasket radial width 304 may be, be about, be at most, or be at most about, 0.05 mm, 0.06 mm, 0.07 mm, 0.08 mm, 0.09 mm, 0.1 mm, 0.11 mm, 0.12 mm, 0.13 mm, 0.14 mm, 0.15 mm, 0.2 mm, 0.3 mm, 0.4 mm, 0.5 mm, 0.6 mm, 0.7 mm, 0.8 mm, 0.9 mm, 1 mm, 1.5 mm or 2 mm, or any range of values therebetween. In some embodiments, the length of the outer radial width 306 may be, be about, be at least, or be at least about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 50 mm or 100 mm, or any range of values therebetween. Although not readily observed from FIG. 2A, in some embodiments, a ratio or an aspect ratio between the center width 302 and the outer radial width 306 may be, be about, be at least, be at least about, be at most, or be at most about, 5:1, 4:1, 3:1, 2:1, 1.5:1, 1:1, 1:1.5, 1:2, 1:3, 1:4 or 1:5, or any range of values therebetween.

As illustrated in FIG. 2B, the port 208 has a port width 308, the center terminal 202 has a center radial width 302, the outer terminal 204 has an outer radial width 306, and the gasket 206 has a gasket radial width 304. As illustrated in FIG. 2B, the port width 308 is associated with a diameter of a circle of the port 208 ending at the center terminal 202, while the center radial width 302, the outer radial width 306 and the gasket radial width 304 are the exposed annulus width portions of the center terminal 202, outer terminal 204 and gasket 206, respectively, as viewed from the top of the cell ending at the gasket 206, pressure venting element 210 or outer terminal 204, respectively. In other embodiments, radial width may be associated with a side or a diagonal length of a polygon (e.g., square) or polygon annulus. In some embodiments, the length of the center radial width 302 may be, be about, be at least, or be at least about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 50 mm or 100 mm, or any range of values therebetween. In some embodiments, the length of the gasket radial width 304 may be, be about, be at most, or be at most about, 0.05 mm, 0.06 mm, 0.07 mm, 0.08 mm, 0.09 mm, 0.1 mm, 0.11 mm, 0.12 mm, 0.13 mm, 0.14 mm, 0.15 mm, 0.2 mm, 0.3 mm, 0.4 mm, 0.5 mm, 0.6 mm, 0.7 mm, 0.8 mm, 0.9 mm, 1 mm, 1.5 mm or 2 mm, or any range of values therebetween. In some embodiments, the length of the outer radial width 306 may be, be about, be at least, or be at least about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 50 mm or 100 mm, or any range of values therebetween. Although not readily observed from FIG. 2B, in some embodiments, a ratio or an aspect ratio between the center radial width 302 and the outer radial width 306 may be, be about, be at least, be at least about, be at most, or be at most about, 5:1, 4:1, 3:1, 2:1, 1.5:1, 1:1, 1:1.5, 1:2, 1:3, 1:4 or 1:5, or any range of values therebetween.

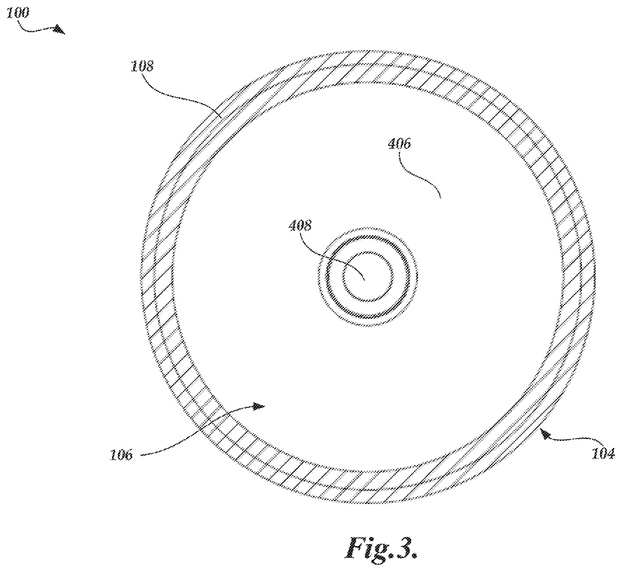

FIG. 3 illustrates the bottom surface 106 of the storage cell 100. The bottom surface 106 may integrate all storage cell features that need not be accessed or interfaced with for cell array or battery pack integration. For example, the bottom surface 106 may contain all functionality other than housing the terminals, such as, but not limited to, geometry for sealing of open side of the cell can and/or geometry for calibrated venting in thermal runaway. Integrating all non-planar, non-terminal features into the bottom surface 106 may allow the top surface 102 to reach a maximum electrical interface area, which may in turn optimize interconnect welding or other assembly process outcomes.

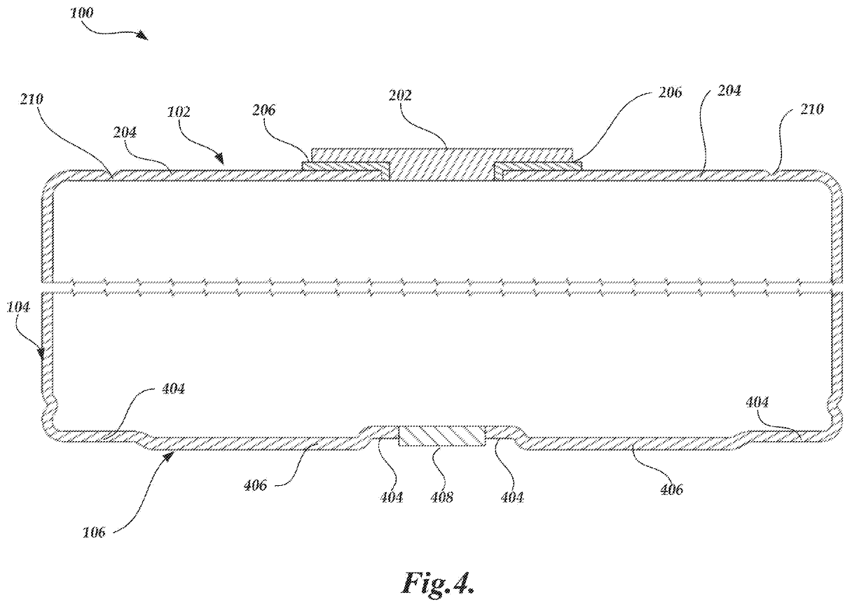

FIG. 4 shows a sectioned side view structural diagram of the top surface 102 and bottom surface 106 of the cell encasing the cell interior 410. The bottom surface can have a port 408 for receiving internal materials or for making physical connections.

In some embodiments, the bottom surface 106 has one or more recessed portions 404 and a line contact base 406. The line contact base 406 is configured to allow the cell to rest on the bottom surface 106 with stability. The line contact base 406 can be an annulus on the bottom surface 106 or substantially annulus relative to a contact surface to provide stability of the cell 100. Alternatively, the line contact base 406 can be three or more points of contact or areas on the bottom surface 106 that are configured to give stability to the cell while the cell is resting on the bottom surface 106. One or more recessed portions 404 can be used to shroud hermetically sealing closures, or the like, on bottom surface 106, or between the bottom surface 106 and the side surface 104. One or more recessed portions 404 can be used for other purposes related to structural integrity of the cell and the bottom surface 106.

In some embodiments, the bottom surface 106 is not contiguous with the side surface 104, such that the bottom surface 106 can be installed and sealed following components internal to the cell (for example, conductors and active material). For example, in some embodiments a housing cap that forms the bottom surface 106 may be installed and attached to the side surface 104. In some embodiments, the bottom surface 106 may include a port for receipt of materials for the battery cell.

Having a top surface 102 that is not contiguous in at least one way (for example, mechanically contiguous, materially contiguous, or any other form of contiguity or continuity) can also be advantageous for fine-tuning pressure vent characteristics, in a manner largely independent of constraints and tradeoffs presented by side surface 104 and bottom surface 106. Additional or alternative subsequent optimizations to the pressure venting element 210 on the top surface 102 can further improve cell failure scenario repeatability, in particular, by further directing high-temperature gas, debris, and flame away from neighboring cells, sensitive components, and product users. By steering these hazards more deterministically, the probability of propagating thermal runaway and injury can be reduced.

The perimeter of the bottom surface 106 may be recessed to accommodate some overlap in the sleeve such that quality defects or thickness changes in the sleeve, or contour changes on the rolled or welded canister edge, do not influence cell alignment precision in the energy storage system. The configuration of the bottom surface 106 may simultaneously protect the sleeve from mechanical wear and abuse from handling and conveyance during manufacturing operations and promote greater contact area between the bottom surface 106 and neighboring components, such as strength-limited adhesives.

With continued reference to FIG. 4, the center terminal 202 may comprise a solid piece of conductive material. The center terminal 202 may be separated from the outer terminal 204 via a terminal insulator gasket (for example, a compressed seal) 206. As described herein, the bottom surface 106 may have a recessed portion 404 over which the sleeve may overlap. The center terminal 202 and outer terminal 204 may comprise any material suitable for laser welding and welding of internal cell structure (for example, aluminum).

In some embodiments, the conductive side surface 104 may be continuous with the outer terminal 204 and may comprise an extruded or drawn aluminum grade for improved thermal conductivity, thermal diffusivity, welding interconnect yield, and gravimetric energy density versus traditionally employed canister materials.

The disclosed energy storage cell design may be used with any internal structure suitable for energy storage devices. One example of a suitable internal design may include a first substrate, an inner separator, a second substrate, and an outer separator. The first substrate may be electrically conductive. The inner separator may be electrically insulative and disposed over (for example, stacked on top of) the first substrate. The electrically conductive second substrate may be further disposed over (for example, stacked on top of) the inner separator. The electrically insulative outer separator may be disposed over (for example, stacked on top of) the second substrate. Upon stacking the first substrate, the inner separator, the second substrate, and the outer separator in a successive manner, the first substrate, the inner separator, the second substrate, and the outer separator may be rolled about a central axis with the first substrate being closest in position to the central axis. In some embodiments, outer separator is absent. The rolled components may then be housed, along with an ion-transfer medium, within the presently disclosed cylindrical energy storage cell design.

In some embodiments, techniques described herein relate to an energy storage device. In some embodiments, the energy storage device includes a first terminal, a second terminal, an energy storage material disposed within a housing, and the housing, where the housing has a housing surface that includes the first terminal and the second terminal. In some embodiments, the first terminal and/or the second terminal are substantially planar. In some embodiments, the housing of the energy storage device is substantially cylindrical.

In some embodiments, the energy storage device further comprises a pressure venting element. In some embodiments, the pressure element includes a material selected from a machined material, a degraded material, a shaped material, and/or combinations thereof. In some embodiments, the pressure venting element includes a material selected from a stamped material, a pierced material, a welded material, an etched material, a chemically treated material, a carved material and/or combinations thereof. In some embodiments, the pressure venting element has a venting surface thickness, and the housing surface has a housing surface thickness, and the venting surface thickness is thinner than the housing surface thickness. In some embodiments, the housing surface includes an external surface and an internal surface, where a position of the pressure venting element is selected from a group including the external surface, the internal surface and/or combinations thereof. In some embodiments, the pressure venting element may correspond to a portion of the housing surface (e.g., top surface) that is thinner than other portions of the surface. For example, in some embodiments the pressure venting element may be structurally formed as one or more grooves and/or dent areas of the surface. In some embodiments, the venting element may be positioned on an internal surface (e.g., within the housing), an external surface (e.g., outside the housing), a top surface, a side surface, a bottom surface, or any combinations thereof. In some embodiments, the pressure venting element comprises a venting pressure (i.e., the internal housing pressure that causes the pressure venting element to be compromised (e.g., partially, substantially or fully rupturing)) is, is about, is at most, or is at most about, 15 Bar, 20 Bar, 21 Bar, 22 Bar, 23 Bar, 24 Bar, 25 Bar, 26 Bar, 27 Bar, 28 Bar, 29 Bar, 30 Bar, 31 Bar, 32 Bar, 35 Bar, 40 Bar, 45 Bar, 50 Bar, 55 Bar, 60 Bar, 65 Bar, 70 Bar or 80 Bar, or any range of values therebetween.

In some embodiments, the first terminal and/or the second terminal has a terminal shape selected from a filled shape (e.g., circular shape) and a non-filled shape (e.g., framed shape or annular shape). In some embodiments, the second terminal encircles the first terminal. In some embodiments, the pressure venting element encircles the first and/or second terminals. In some embodiments, the housing surface includes a top surface, a side surface and a bottom surface, where the top surface includes the first terminal and the second terminal. In some embodiments, the first terminal and/or the second terminal are substantially planar. In some embodiments, the first terminal and/or the second terminal protrudes from the top surface. In some embodiments, the first terminal and/or second terminal is substantially level with the top surface. In some embodiments, the first terminal and/or the second terminal cover, cover about, cover at least, or cover at least about, 50%, 55%, 60%, 65%, 70%, 75%, 80%, 85%, 90%, 92%, 95%, 98%, 99% or 100% of a surface area of a housing surface (e.g., the top surface), or any range of values therebetween. In some embodiments, the first terminal has a width size (e.g., center width or radial width) of, of about, of at least, or of at least about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 50 mm or 100 mm, or any range of values therebetween. In some embodiments, the second terminal has a width size (e.g., center width or radial width) of, of about, of at least, or of at least about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 50 mm or 100 mm, or any range of values therebetween. In some embodiments, an aspect ratio between the first terminal size: second terminal size is, is about, is at least, is at least about, is at most, or is at most about, 5:1, 4:1, 3:1, 2:1, 1.5:1, 1:1, 1:1.5, 1:2, 1:3, 1:4 or 1:5, or any range of values therebetween. For example, if the center width or radial width of the first terminal is 10 mm, and the center width or radial width of the second terminal is 15 mm, the aspect ratio of the first terminal size: second terminal size is 1:1.5. In some embodiments, the first and/or the second terminals are substantially flat. In some embodiments, the first and second terminals are coplanar. In some embodiments, the flatness or roughness (e.g., RMS) of a terminal (e.g., the first terminal and/or the second terminal) may be, be about, be at most, or be at most about, 2 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm or 500 μm, or any range of values therebetween.

In some embodiments, the first terminal, the second terminal and the pressure venting element are positioned on the top surface. In other embodiments, the first terminal and the second terminal are positioned on the top surface, and the pressure venting element is positioned on the bottom surface. In still other embodiments, the first terminal and the second terminal are positioned on the top surface, and the pressure venting element is positioned on the side surface. In some embodiments, the top surface is substantially circular. In some embodiments, the bottom surface includes a substantially annulus shaped surface.

In some embodiments, the energy storage device further includes a terminal insulator gasket. In some embodiments, the terminal insulator gasket is positioned between the first terminal and the second terminal. In some embodiments, the terminal insulator gasket is positioned between the first terminal and the second terminal such that the first and second terminals do not physically and directly contact one another. In some embodiments, the insulator gasket covers a portion of the surface of the first and/or second terminal. In some embodiments, the length of the gasket radial width may be, be about, be at most, or be at most about, 0.05 mm, 0.06 mm, 0.07 mm, 0.08 mm, 0.09 mm, 0.1 mm, 0.11 mm, 0.12 mm, 0.13 mm, 0.14 mm, 0.15 mm, 0.2 mm, 0.3 mm, 0.4 mm, 0.5 mm, 0.6 mm, 0.7 mm, 0.8 mm, 0.9 mm, 1 mm, 1.5 mm or 2 mm, or any range of values therebetween.

In some embodiments, the first terminal or second terminal is a cathode terminal. In some embodiments, the first terminal or the second terminal is an anode terminal. In some embodiments, the energy storage device further includes a positive lead in contact with the anode terminal, and/or a negative lead in contact with the cathode terminal. In some embodiments, the positive lead and the negative leads are respectively attached (e.g., welded) to the anode terminal and the cathode terminal. In some embodiments, the weld may be selected from a laser weld, ultrasonic bonding weld, resistance weld, and TIG weld. In some embodiments, the weld is a laser weld.

In some embodiments, the energy storage device further includes a housing cap. In some embodiments, the housing cap forms the bottom surface of the housing. In some embodiments, the energy storage device further includes a housing port. In some embodiments, the housing port is positioned on the top surface and/or the bottom surface. In some embodiments, the housing port is encircled by the first terminal, the second terminal, the insulating gasket, and/or the pressure venting element. In some embodiments, a portion of the housing surface is substantially ferrous. In some embodiments, the energy storage device is a battery.

### Product Systems

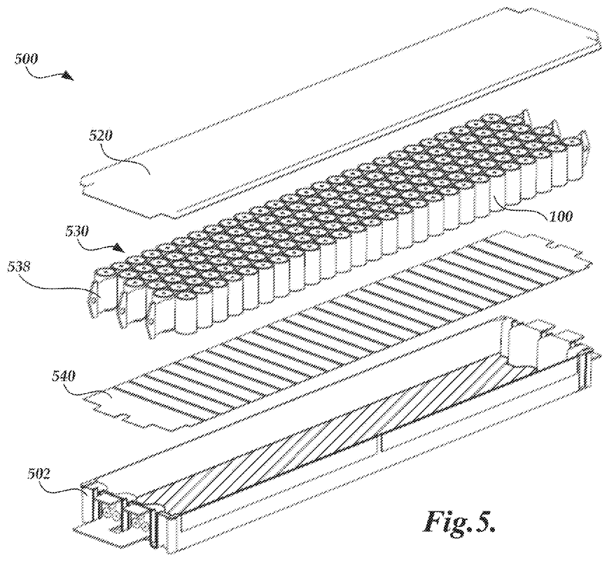

FIG. 5 illustrate an example energy storage system 500 in which storage cells 100 may be used in a cell array 530. In one embodiment, the storage cells 100 may be arranged as modules in common orientation. In other embodiments, arrays of cells may be arranged as modules in alternating or staggered orientation. In some embodiments, the storage cells 100 may have sleeves 108 and may be arranged directly adjacent to each other. In other embodiments, the storage cells 100 may not have sleeves 108 and may therefore be arranged with some distance between each cell. In some embodiments, the storage cells 100 may be electrically interconnected via a lower-side voltage brick foil sheet 540, where the foil sheet 540 is laser-welded to create an electrical connection with the cells 100, sensing electronics, and positive/negative array terminals. In other embodiments, the foil sheet 540 may be omitted entirely. In other embodiments, the storage cells 100 are interconnected via another means. The side surfaces 104 of the storage cells 100 may be cooled using a thermal component 538. The cell array may be contained within a frame structure 502 and sealed with a lid 520.

The interconnects between the storage cells 100 can also be configured to ensure product durability under normal stresses but can be configured to sever from terminals on the storage cells 100 when under undesirable mechanical and thermal loads, such as thermal runaway. The interconnects could be adjusted to different widths or thicknesses to sever from terminals on the storage cells 100. Other stress-concentrating geometry can be added to the interconnects to allow for severance, for example weld pattern, shape, footprint area, power, and penetration. Additionally, the interconnect material can be configured from a material with a lower melting temperature.

In some embodiments, techniques described herein relate to an energy storage device array. In some embodiments, the energy storage device array includes multiple energy storage devices, where each of the energy storage devices may be any of the energy storage device described above. In some embodiments, techniques described herein relate to an electric vehicle that includes an energy storage device, such as any of the energy storage device described above.

### Energy Storage Device Manufacturing Processes

In some embodiments, the techniques described herein relate to a process of manufacturing an energy storage device, such as the cell 100. In some embodiments, the process of manufacturing an energy storage device may include disposing an energy storage material within the housing; and attaching the energy storage material within the housing. In some embodiments, the process further includes forming a pressure venting element on a housing surface of a housing. In some embodiments, the housing surface includes a first terminal and a second terminal. In some embodiments, a cap is attached to the housing subsequent to disposing the energy storage material within the housing.

### Energy Storage Device Array Manufacturing Processes

In some embodiments, the techniques described herein relate to a process of manufacturing an energy storage device array, such as the cell array 530. For example, the process of manufacturing an energy storage device array may include disposing at least one or multiple energy storage devices into an array housing; contacting a first lead to a first terminal of the energy storage device and a second lead to a second terminal of the energy storage device; and attaching the first lead to the first terminal of the energy storage device and the second lead to the second terminal of the energy storage device. In some embodiments, attaching comprises welding (e.g., laser welding). In some embodiments, the position of the battery is not adjusted after the energy storage device is disposed into the array housing. The ability to attach leads to an energy storage device within an array without adjustment may be enabled by utilizing terminals as described herein, for example as illustrated by any one of FIGS. 1-5.

While certain embodiments have been described, these embodiments have been presented by way of example only, and the foregoing disclosure is not intended to limit the present disclosure to the precise forms or particular fields of use disclosed. Indeed, the novel methods and systems described herein may be embodied in a variety of other forms. Furthermore, various omissions, substitutions and changes in the systems and methods described herein may be made without departing from the spirit of the disclosure. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. The accompanying claims and their equivalents are intended to cover such forms or modifications as would fall within the scope and spirit of the disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed cell assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (for example, attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

1. An energy storage device, comprising:
a first terminal;
a second terminal;
a pressure venting element;
a housing comprising a housing surface, wherein the housing surface comprises the first terminal, the second terminal and the pressure venting element; and
an energy storage material disposed within the housing.

2. The energy storage device of claim 1, wherein the pressure venting element comprises a material selected from a group consisting of a machined material, a degraded material, a shaped material, a stamped material, a pierced material, a welded material, an etched material, a chemically treated material, a carved material, and combinations thereof.

3. (canceled)

4. The energy storage device of claim 1, wherein the pressure venting element comprises a venting surface thickness, the housing surface comprises a housing surface thickness, and the venting surface thickness is thinner than the housing surface thickness.

5. The energy storage device of claim 1, wherein the housing surface comprises an external surface and an internal surface, wherein a position of the pressure venting element is selected from a group consisting of the external surface, the internal surface, and combinations thereof.

6. The energy storage device of claim 1, further comprising a terminal insulator gasket positioned between the first terminal and the second terminal.

7. The energy storage device of claim 1, wherein the housing surface comprises a top surface, a side surface and a bottom surface, and wherein the housing surface comprises a configuration selected from the group consisting of: (i) wherein the first terminal, the second terminal and the pressure venting element are positioned on the top surface; (ii) wherein the first terminal and the second terminal are positioned on the top surface, and the pressure venting element is positioned on the bottom surface; and (iii) wherein the first terminal and the second terminal are positioned on the top surface, and the pressure venting element is positioned on the side surface.

8. (canceled)

9. (canceled)

10. (canceled)

11. (canceled)

12. (canceled)

13. The energy storage device of claim 1, and 12, wherein the first terminal is encircled by the second terminal, and wherein the pressure venting element encircles the first terminal and the second terminal.

14. (canceled)

15. (canceled)

16. The energy storage device of claim 1, wherein the first terminal and the second terminal together cover at least about 50% of a surface area of a top surface.

17. (canceled)

18. (canceled)

19. (canceled)

20. (canceled)

21. (canceled)

22. (canceled)

23. The energy storage device of claim 1, wherein an aspect ratio of a first terminal size: a second terminal size is about 3:1 to about 1:3.

24. The energy storage device of claim 23, wherein the first terminal is a cathode terminal and the second terminal is an anode terminal.

25. The energy storage device of claim 24, further comprising a positive lead in contact with the anode terminal and a negative lead in contact with the cathode terminal.

26. The energy storage device of claim 25, wherein the positive and negative leads are respectively welded to the anode and cathode terminals.

27. The energy storage device of claim 26, wherein the positive and negative leads are respectively laser welded to the anode and cathode terminals.

28. (canceled)

29. The energy storage device of claim 1, wherein the pressure venting element comprises a venting pressure of at least about 20 Bar.

30. (canceled)

31. (canceled)

32. An energy storage device, comprising:
a first terminal;
a second terminal, wherein the second terminal encircles the first terminal;
an insulating gasket positioned between the first terminal and the second terminal;
a housing comprising a housing surface; and
an energy storage material disposed within the housing;
wherein the housing surface comprises a top surface, a side surface and a bottom surface;
wherein the top surface comprises the first terminal and the second terminal; and
wherein the first terminal and the second terminal are each substantially planar.

33. The energy storage device of claim 32, wherein the first terminal protrudes from the top surface.

34. The energy storage device of claim 32, wherein the second terminal is substantially level with the top surface.

35. The energy storage device of claim 32, wherein the first terminal and the second terminal together cover at least about 50% of a surface area of the top surface.

36. (canceled)

37. (canceled)

38. The energy storage device of claim 32, wherein an aspect ratio of a first terminal size: a second terminal size is about 3:1 to about 1:3.

39. (canceled)

40. (canceled)

41. (canceled)

42. A process of manufacturing an energy storage device, comprising:
forming a pressure venting element on a housing surface of a housing, wherein the housing surface comprises a first terminal and a second terminal;
disposing an energy storage material within the housing; and
attaching the energy storage material to the first terminal and the second terminal.

43. (canceled)

44. (canceled)

45. (canceled)
